(19) United States
(12) Patent Application Publication
(10) Pub. No.: US 2025/0171668 A1
(43) Pub. Date: May 29, 2025

(54) Electromagnetically Activated Moisture Reactive Solid Adhesive

(71) Applicant: LAYA CHEMICAL ENGINEERING CO., LTD., Douliu City (TW)

(72) Inventors: WEN-CHIH LIN, DOULIU CITY (TW); LI-YUNG HSU, TAICHUNG CITY (TW)

(21) Appl. No.: 18/521,012

(22) Filed: Nov. 28, 2023

(51) Int. Cl. C09J 175/14

(52) U.S. Cl. CPC C09J 175/14

(57) ABSTRACT

The present invention relates to an adhesive, in particular to a solid adhesive that can be activated by electromagnetic activation and react in a humid environment, which can rapidly concentrate the charged structure of the electromagnetically polarized active agent by rapidly changing the positive and negative electric fields and disperse, and so as to break the hydrogen bonded crystalline structure of the moisture reactive solid adhesive to liquefy and reach the adhesive function.

### BACKGROUND OF THE INVENTION

### Field of the Invention

The present invention relates to an adhesive, in particular to a solid adhesive that can react in a humid environment by using electromagnetic activation.

### Description of the Related Art

Adhesive, shortly speaking, is a substance that can make two interfaces adhere to each other. It has a wide range of uses and many types. It has multiple functions and can be applied to the production of adhesive tapes to facilitate people's use. Adhesive tape is absolutely convenient and easy-to-use daily necessities. It can be pasted immediately and can be applied to a variety of objects with different purposes and shapes, such as LCD TVs, mobile phones, and automobiles. In auto parts, due to the need for long-term stability, the adhesive must have sufficient strength; the protection film of the mobile phone screen must be easy to peel off without leaving adhesive residue; the polarizing film must use a transparent and weather-resistant adhesive; internally, adhesives with low VOC (volatile organic compounds) must be used. Another example is the adhesive used in silicon wafer and ceramic manufacturing process, which can maintain a certain strength under normal conditions, but its strength will weaken after overheating or exposure to ultraviolet rays.

The types of adhesives include rubber adhesives, acrylic adhesives and silicone adhesives according to the different uses, as follows:
A. Rubber adhesive: made of natural rubber, but the natural rubber itself has low adhesive force, so generally some kind of tackifier will be added so that the rubber adhesive can be attached to various items, and also can be used in packing tape.
B. Acrylic adhesive: use acrylic acid monomer is applied to carry out co-polymerization, the multifunctional acrylic polymer can be synthesized and use as adhesive, because of its characteristics of transparency, weather resistance, heat resistance and solvent resistance are extremely excellent, so it can be widely used in the fields of liquid crystal panels, mobile phones and automotive supplies. However, when using it, it is necessary to consider the temperature, durability and heat resistance of the adhesive when it bears the best adhesion, as well as the copolymerization of acrylic monomers.
C. Silicone adhesive: Silicone has excellent resistance to extreme heat and cold environments, and has an extremely wide temperature duration range. However, because the adhesive force of silicone rubber itself is not high, silicone resin is used as a tackifier, and the required adhesive properties can be obtained by changing the structural ratio of silicone rubber and silicone resin, and benzyl peroxide can also be used, and other cross-linking agents to produce cross-linking, thereby improving its heat resistance.
D. Polyurethane adhesive: This adhesive has excellent removability, so it is mostly used in protective film and fluff removal equipment.

The reason why the adhesive can interact with the attached object is mainly because most of the adhesive is a polymer substance, not only the molecules themselves can be linked into a solid structure, but also can be combined with other substances by chemical chains or mechanical forces for bonding. The most basic source of adhesive force for adhesives is the use of intermolecular attraction (bonding), such as hydrogen bonding, and the van der Waals force (non-oriented, non-directional, between molecules or atoms that any adhesive will produce, the so-called saturated interaction force) and so on. However, the working distance of the molecular force is usually very small. In order to generate more molecular force, the adhesive is generally in a liquid state, and uses its fluidity to fill the concave holes on the surface of the object to increase the close contact area.

Glue is used in industry very common, its main components are polyvinyl alcohol (DVA) and borax. Polyvinyl alcohol is a water-soluble plastic. Adding borax, boron atoms and oxygen atoms will string polyvinyl alcohol molecules together, wherein, viscous liquid formed is glue, which will slowly solidify in the air, and it will be glued to the uneven surface of the object by mutual interlocking, so that the object can resist the external force that wants to separate the two objects. This is the principle of mechanical interlocking.

There are many ways to solidify the adhesive, the most common being hot melt adhesive, which melts into a liquid state at high temperature (65-180° C.) and has fluidity. After cooling, it solidifies and becomes viscous. The agent is solidified when the solvent evaporates and dries up.

In addition to curing by physical means, there is also curing by chemical reaction. For example, the main component of three-second glue is cyanoacrylate, which will quickly polymerize with water vapor in the air at room temperature, and harden within seconds. A strong adhesive; AB glue with strong adhesion after drying is also an example. After mixing the two liquid glues A and B, the two agents will react with each other to form a polymer and solidify.

The cured adhesive can not only generate mechanical force with the adherent, but also strengthen its own structure, because some adhesives make the adhesive molecules closer to each other due to solvent volatilization during the curing process, thus producing more molecules force. In addition, the molecules of some adhesives will be entangled with each other, making objects bonded more firmly, and super glue belongs to this type of adhesive.

It can be seen from the above description that the basic combination method of the adhesive is nothing more than using the liquid to moisten the surface of the object first, and then interlocking with the object through solidification to achieve a tight combination.

However, the super glue in the adhesive is preserved by a solvent, and the solvent and the solute can be roughly divided into polar (hydrophilic) and non-polar (hydrophobic) ones. The polarity of a solvent determines the substances that can dissolve and other solvents or liquid substances that can be mixed with each other, so polar substances dissolve best in polar solvents, which is the principle of like one dissolves like one only. For example, inorganic salts and sugars such as table salt and sucrose are highly polar substances and are only soluble in highly polar solvents such as water; strong non-polar substances such as oils, resins, waxes are only soluble in hexane of very non-polar organic solvents, which polar and non-polar solvents cannot mix and dissolve each other. Polar solvents can be subdivided into polar proton solvents and polar aprotic solvents.

General adhesives as mentioned above, especially for industrial users, use solvents that are non-polar solvents, and its comparatively well-known ones include hexane (CH₃—CH₂—CH₂—CH₂—CH₃), benzene (C₆H₆), toluene (C₆H₅—CH₃), diethyl ether (CH₃—CH₂—O—CH₂—CH₃), chloroform (CHCl₃), etc., but in practical applications, the industry will still use the solvent's boiling point (including melting point), polarity, density, price, and even toxicity, safety, etc. into consideration.

However, the non-polar solvent itself or the reactant after the reaction has no shortage of substances that are harmful to the human body, such as benzene. If it is inhaled into the human body or touches the skin, it will cause benzene poisoning. In severe cases, headache, nausea, vomiting, coma, convulsions, etc. will occur, and even cause central nervous system paralysis and death. Benzene is also a Group I carcinogen identified by the International Cancer Center (IARC), which can damage bone marrow, reduce the number of red blood cells, white blood cells, platelets, and cause chromosomal aberrations, leading to leukemia! Therefore, in the industry, all of the above-mentioned general adhesion provide with the necessary and urgency to be improved.

In view of the above-mentioned major defects in the above-mentioned commonly used adhesives, the inventors had the idea to innovate them. After many years of research, experiments, reviews, corrections, and re-tests, the Electromagnetic Activated Moisture Reactive Solid Adhesives of the present invention was finally achieved.

### SUMMARY OF THE INVENTION

Therefore, the present invention is objected to provide an electromagnetically activated moisture-reactive solid adhesive, which does not utilize a solvent to preserve, therefore, it does not need to come into contact with a solvent to cause a dangerous situation when using the conventional adhesive, which is one of the main object of the present invention.

According to the electromagnetically activated moisture-reactive solid adhesive of the present invention, when it is in use, especially in industrial use, there is no need for complicated procedures such as general adhesives in use, and its manpower can be greatly reduced, and can save the effect of manpower expenditure, which is the second purpose of the present invention.

According to the electromagnetically activated moisture-responsive solid adhesive of the present invention, when it is in use, especially in industrial use, there is no need for complicated procedures like ordinary adhesives in use, and its manpower can be greatly reduced, and the energy consumed during operation can be saved, under the situation that energy is in short supply all over the world at present, a smooth way is provided, which is another object of the present invention.

According to the electromagnetically activated moisture-reactive solid adhesive of the present invention, because its process and manpower can be greatly reduced, the working space can be greatly reduced, which is another purpose of the present invention.

According to the electromagnetically activated moisture-reactive solid adhesive of the present invention, the effect of utilization is achieved through a simpler process and method, and its manpower can be greatly reduced, and its operating device can be greatly improved, and its efficiency is higher. High, lower production costs, which is another purpose of the present invention.

As for the electromagnetically activated moisture-reactive solid adhesive of the present invention, its detailed structure, specific embodiments and other effects can be fully understood by referring to the following descriptions in accordance with the accompanying drawings.

### BRIEF DESCRIPTION OF THE DRAWINGS

FIG. 1A is a flow chart of the manufacture of the electromagnetically activated moisture-reactive solid adhesive of the present invention.

FIG. 1B shows the chemical reaction formula of the manufacturing process of the electromagnetically activated moisture-reactive solid adhesive of the present invention.

FIG. 2A is a flow chart of the manufacture of the electromagnetic polarizing active agent used in the manufacture of the electromagnetically activated moisture-reactive solid adhesive of the present invention.

FIG. 2B shows a schematic diagram of the chemical reaction diagram of the manufacturing process in FIG. 2A.

FIG. 3A is a solid crystal chemical structure diagram of the electromagnetically activated moisture-reactive solid adhesive of the present invention that has not been electromagnetically polarized.

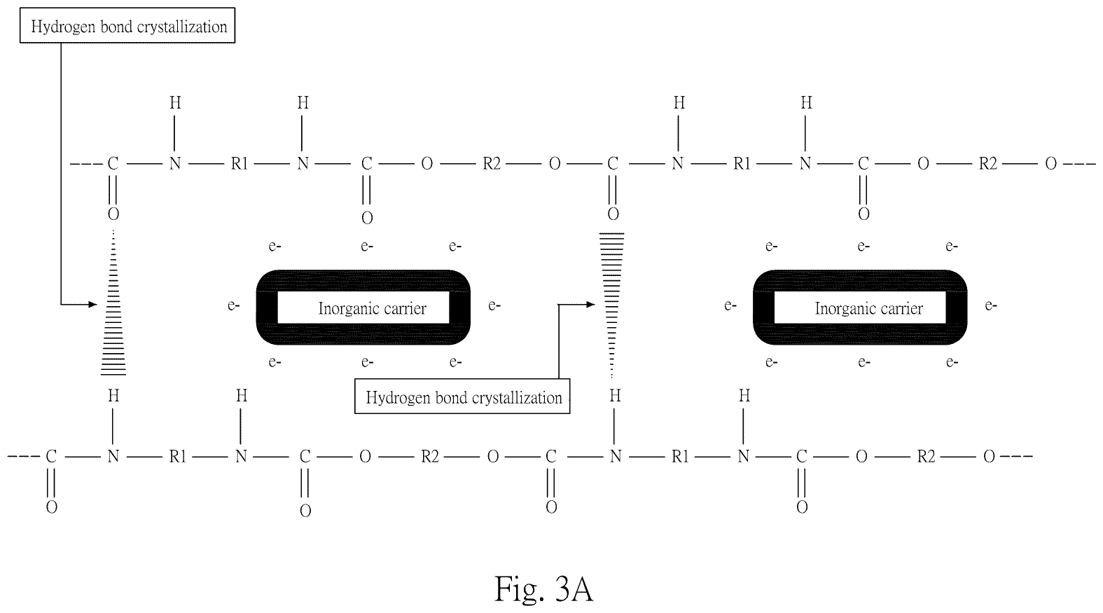

FIG. 3B and FIG. 3C show the schematic diagram of the electromagnetically activated moisture-reactive solid adhesive in FIG. 3A being electromagnetically polarized to break the polyurethane hydrogen bond crystallization and transform from a crystalline solid state to a non-crystalline liquid state.

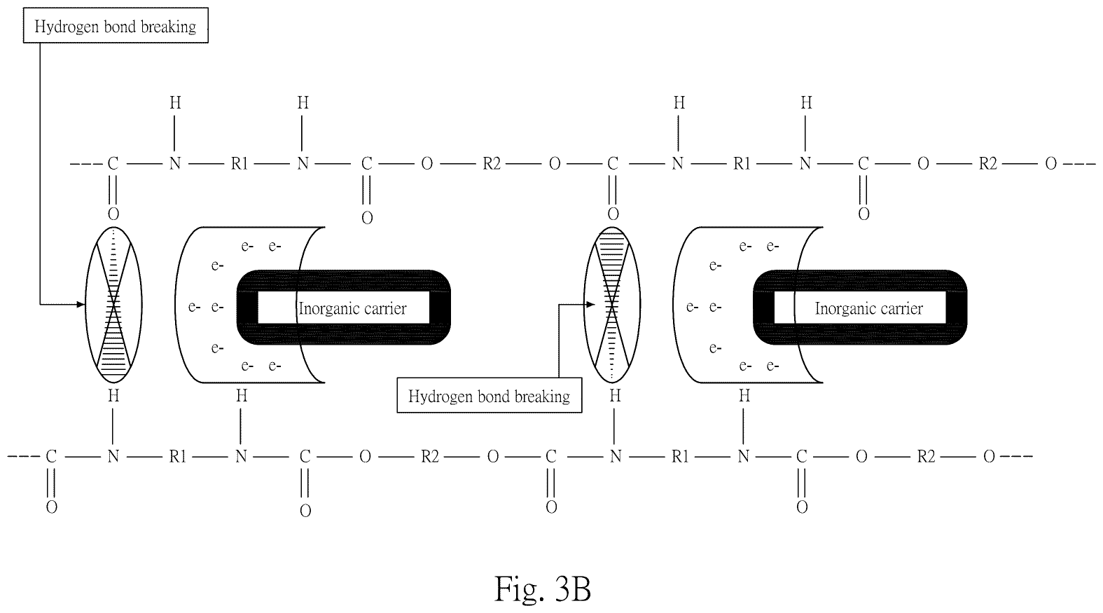

FIG. 4 shows the structure of silver nanowire.

FIG. 5 shows the structure of carbon nanotube.

### DETAILED DESCRIPTION OF PREFERRED EMBODIMENT

The electromagnetically activated moisture-reactive solid adhesive of the present invention can quickly concentrate and disperse the charged structure of the electromagnetically polarized active agent by rapidly changing the positive and negative electric fields, thereby interrupting the moisture-reactive solid adhesive. The hydrogen-bonded crystalline structure makes it liquefied to reach the adherents. Its composition is stated as follows:

The composition of the electromagnetically polarized moisture-reactive solid glue is:
1. Prepolymer: also known as prepolymer, generally also known as Polyol, molecular weight is 200-10000 medium and long chain structure, so physical properties are very poor, it is monomer substances initially aggregated. It is used when it is difficult to completely polymerize a monomer into a polymer at one time, or to avoid the occurrence of cavities and cracks in the polymer during processing. It also refers to a lower molecular weight between the monomer and the final polymer. The polymer usually refers to the polymer in the previous stage of preparing the final polymer.

The preferred prepolymer used in the present invention are as follows:
a) Polyester prepolymer (polyester polyol), its chemical formula is:

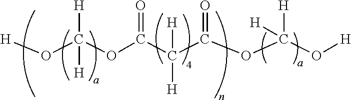

Wherein, a, n are positive integers from 1-99.
b) Polyether prepolymer (polyether polyol), its chemical formula is:

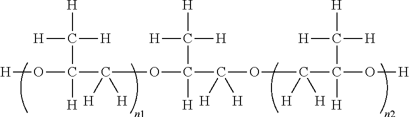

Wherein, n1, n2 are positive integers from 1-99.
c) Polytetrahydrofuran type prepolymer (Polytetrmethylene ether glycol polyol), its chemical formula is:

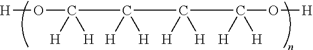

Wherein, n is a positive integers from 1-99.
d) Polycaprolactone type prepolymer (Poly-caprolactone polyol), its chemical formula is:

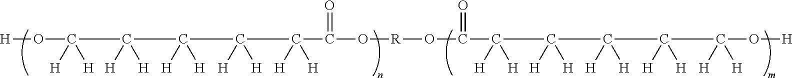

Wherein, n, m are positive integers from 1-99.
e) Polycarbonate prepolymer (Polycarbonate polyol), its chemical formula is:

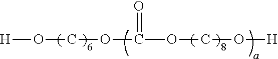

Wherein, n is a positive integers from 1-99.
f) Polyhydroxyl-terminated acrylate polyol (Polyhydroxyl-terminated acrylate polyol), its chemical formula is:

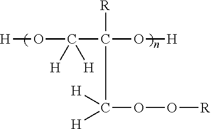

Wherein, n is a positive integer from 1-99; R is an alkane hydrogen compounds of chemical formula CnH₂ₙ₊₂ or CnH₂ₙ, wherein, n is positive integer from 1-99.
g) Polyhydroxyl-terminated polybutadiene type prepolymer, its chemical formula is:

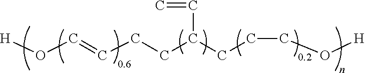

Wherein, n is a positive integer from 1-99.
h) poly-terminated epoxy type prepolymer, its chemical formula is:

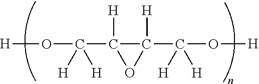

Wherein, n is a positive integer from 1-99.

The above-mentioned prepolymer has a common feature, which can be seen from its chemical formula, that is, its end group is a hydroxyl group (Hydroxy bond-OH). The individual prepolymers can be mixed in order to adjust the physical properties of the solid adhesive.
2. Diisocyanate curing agent: it is highly toxic, but as mentioned above, the molecular weight of polyol Polyol is a medium and long chain structure of 200-10000, and the functional genes of NCO at both ends of diisocyanate will interact with polyol The hydrogen and oxygen (OH) functional genes at both ends react to form amino acid formate. At this time, a polymerization reaction will occur, which will increase the molecular weight of the prepolymer from 200-10000 to more than 100,000-400,000, and the physical properties will be improved a lot. Urethane is a stable, environmentally friendly and non-toxic compound, which is due to the non-toxic property of diisocyanate and polyol prepolymer after polymerization.

The preferred diisocyanate that the present invention adopts is as follows:
a) diphenylmethane diisocyanate, its chemical formula is:

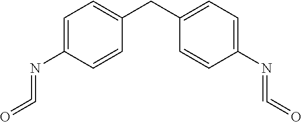 [SMILES: O=C=Nc1ccc(Cc2ccc(N=C=O)cc2)cc1]

b) toluene diisocyanate, its chemical formula is:

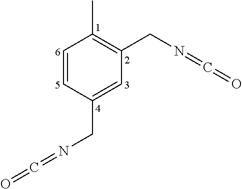

c) 1,5-naphthalene diisocyanate, its chemical formula is:

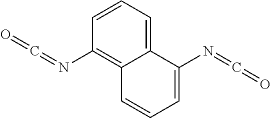 [SMILES: O=C=Nc1cccc2c(N=C=O)cccc12]

d) isophorone diisocyanate, its chemical formula is:

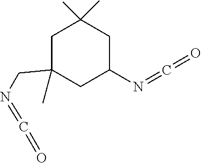 [SMILES: CC1(C)CC(N=C=O)CC(C)(CN=C=O)C1]

e) hydrogenated diphenylmethane diisocyanate (4,4′-dicyclohexyimthane diisocyanate), its chemical formula is:

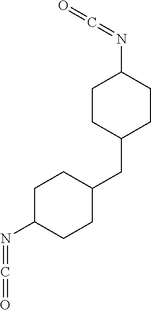 [SMILES: O=C=NC1CCC(CC2CCC(N=C=O)CC2)CC1]

3. Tackifier: it is used to increase the surface wettability of the adhesive to the adhered substrate. The tackifier will reduce the cohesion of the polymer, improve the fluidity, and penetrate into the surface of the adhered substrate. Surface capillary pores increase the contact surface area and wettability without substantially changing the physical properties of other properties. The preferred ones have the characteristics of low acid value, good miscibility, low melting point, water resistance, ethanol resistance and chemical resistance.

The preferred tackfier that the present invention adopts is as follows:
a) abietic resin, its chemical formula is:

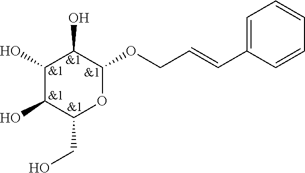 [SMILES: OC[C@H]1O[C@@H](OC/C=C/c2ccccc2)[C@H](O)[C@@H](O)[C@@H]1O]

b) terpene resin, its chemical formula is:

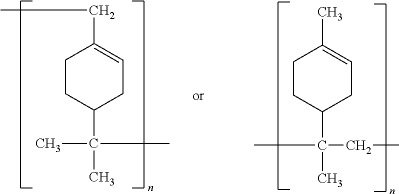

Wherein, n is a positive integer from 1-99.
c) Petroleum resin (hydrocarbon resin, HCR): it is a kind of thermoplastic resin produced by pretreatment, polymerization, distillation and other processes of C5, C6, C9 and other fractions produced by petroleum production plants. According to different raw materials, it is divided into multiple types, without a single structural formula, and the preferred ones are:
1. C5 Petroleum resin.
2. C6 Petroleum resin.
3. C9 Petroleum resin.
4. Auxiliary: based on monomers, polymers, oligomers

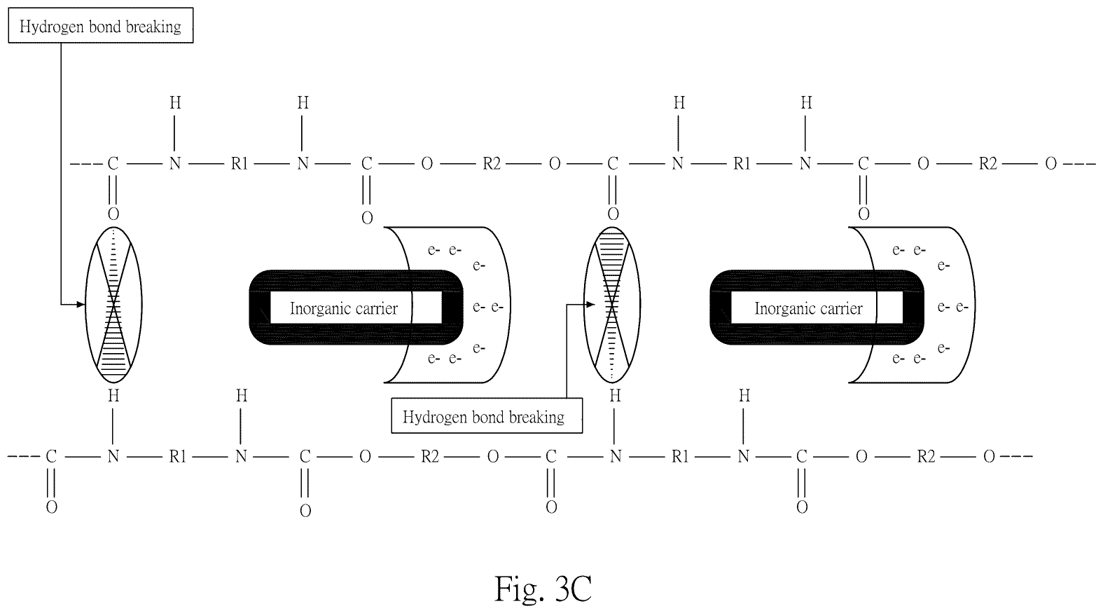

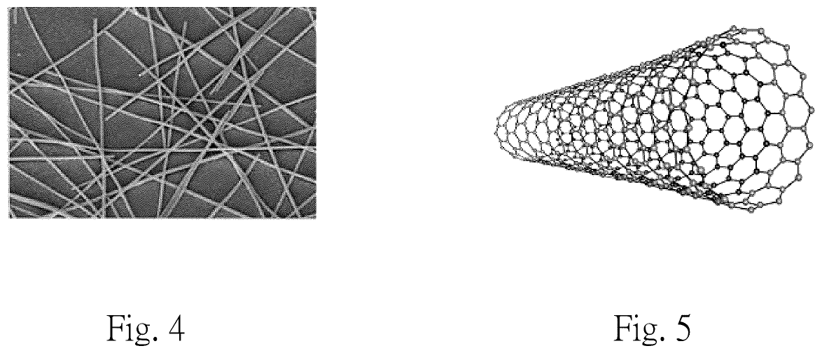

and surfactants, it has the ability to defoam, prevent precipitation, increase viscosity, improve product appearance, and improve sag resistance, color development, viscosity reduction, gloss enhancement, certainty, and balance effects (the structure of additives is confidential for each manufacturer, and no structural formula has been found). For example, it can be: a) antifoaming agent, b) leveling agent, c) anticratering agent, d) rheological agent (dilatant thickener), e) thixotropic agent (thixotropy).
5. Filler: also known as filler, bulking agent, refers to the improvement of work performance, product strength, etc., can be: a) Talcum powder, b) Calcium carbonate, c) Kaolin (Kaolin), etc.
6. Electromagnetically polarized active agent carrier: it refers to the carrier that can be used to carry electromagnetically polarized active agent in the present invention, it is preferably following powdery, granular compound: a) Quartz, b) Zirconia, c) Silicon Carbide, d) Zinc oxide, e) Calcium Oxide, f) Magnesium oxide, g) Copper oxide, h) Calcium carbonate, i) Mica, j) Iron oxide, k) Alumina, I) Carbon, m) Graphite and its isomers, n) solid polymer microspheres, o) hollow polymer microspheres (Silica Microspheres).
7. Resistance adjuster: it is a conductive compound and a polymer used to adjust the trace resistance on the surface of the carrier, including:
a) polystyrene sulfonate (poly (3,4-ethylenedioxythiophene)): polythiophene, its chemical formula is:

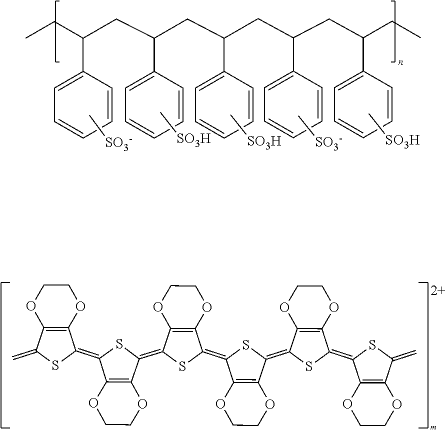

Wherein, n is a positive integer from 1-99.
b) Silver nanowire: its structure is as FIG. 4.
c) carbon nanotube: its structure is as FIG. 5, and which is used to create Nantero's NRAM, 50 times stronger than steel, 1/50,000^{th} the diameter of a human hair.
d) Graphene: its structure is as follows:
e) Tetramethylbutyl) phenoxy] ethoxy) ethanol, its chemical formula is:

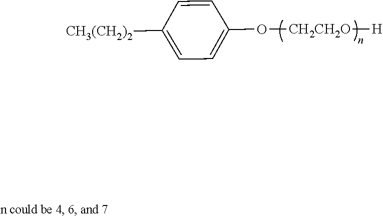

f) monoalkyl ether phosphate (Monoalkyl ether phosphate): its chemical formula is:

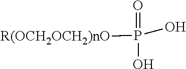

Wherein, n is a positive integer from 1-99.
8. Catalyst: it is used to accelerate the polymerization reaction, comprising:
a) dibutyltin dilaurate: its chemical formula is:

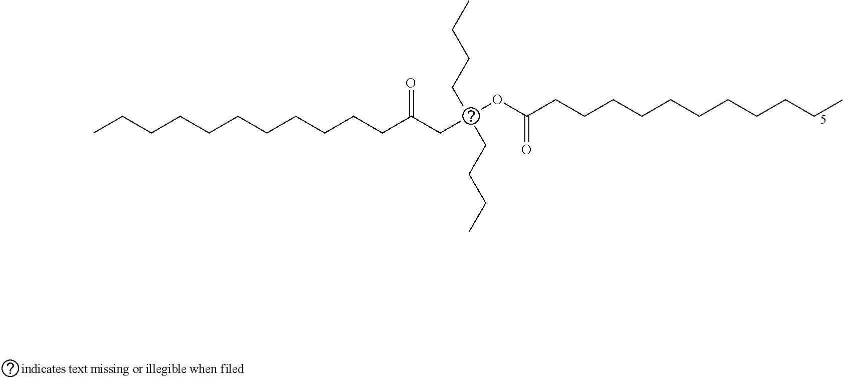 [SMILES: CCCCCCCCCCCC(=O)CC(CCCC)(CCCC)OC(=O)CCCCCCCCCCC]

b) N,N-Dimethyltrimethylenediamine: its chemical formula is:

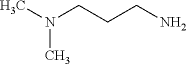

9. Coupling agent: it is an additive to improve the interfacial properties of synthetic resins and inorganic fillers or reinforcing materials in plastic compounding, also known as surface modifier, which is used in plastic processing It can reduce the viscosity of synthetic resin melt, improve the dispersion of fillers to improve processing performance, and then make the product obtain good surface quality and mechanical, thermal and electrical properties. The coupling agent generally consists of two parts, one part is an inorganic group that can interact with inorganic fillers or reinforcing materials, and the other is an organic group that can interact with synthetic resins. Include:
a) Dibutyltin dilaurate, its chemical formula is as follows:

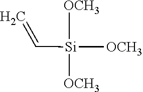

b) Vinyl triethoxy silane, its chemical formula is as follows:

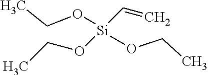

c) 3-isocyanatopropyl (trimethoxy) silane, the chemical formula is as follows:

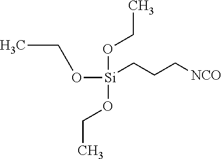

d) (3-aminopropyl) triethoxysilane, the chemical formula is as follows:

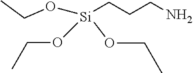

e) (3-aminopropyl) trimethoxysilane, the chemical formula is as follows:

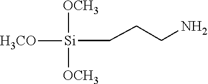 [SMILES: CO[Si](CCCN)(OC)OC]

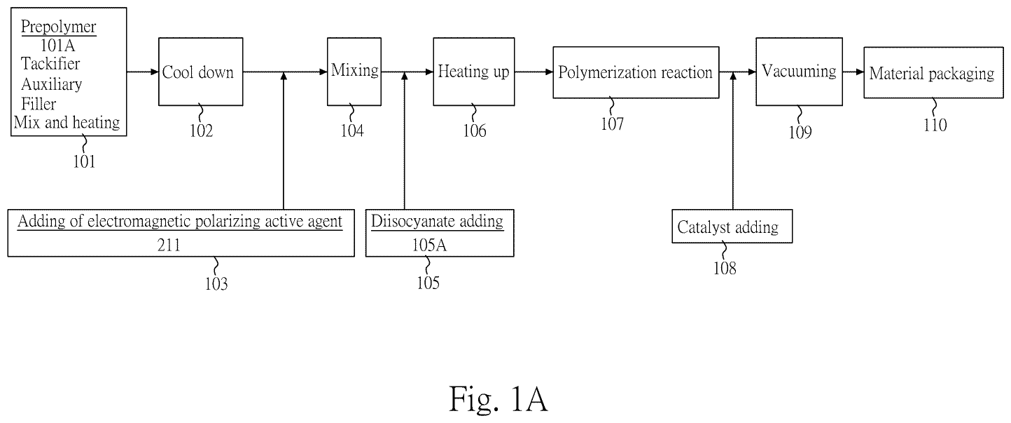

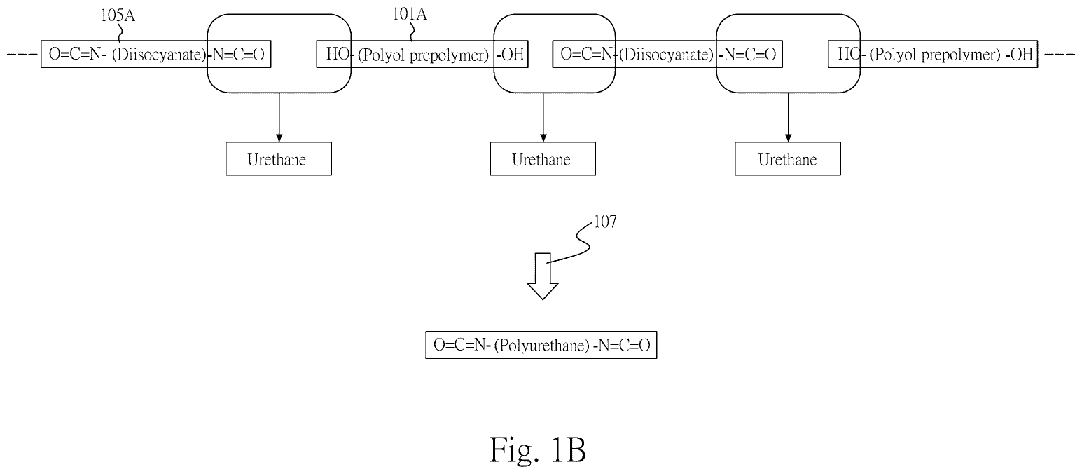

The manufacturing process of the electromagnetically polarized moisture-reactive solid adhesive of the present invention is as shown in FIG. 1A and FIG. 1B:
1. As shown in FIG. 1A, first, the prepolymer (10-95%), tackifier (1-30%), auxiliary agent (0.01-10%), filler (1-30%), one or more, mixed and heated to 100° C.-150° C., dried and dehydrated under vacuum at 650-760 mmHg for 30 minutes-4 hours (101), to obtain a prepolymer without trace water molecules, to prevent the diisocyanate from reacting with the water molecules with higher reactivity with the hydroxyl group first, and after the water molecules have reacted, they will react with the polyol prepolymer with lower reactivity with the hydroxyl group, so as not to cause incomplete polymerization of polyol prepolymer.
2. Lower the temperature to below 70° C. 102 and add electromagnetic polarizing active agent (its manufacture is described later), slowly add polyisocyanate 105 after mixing under nitrogen atmosphere, heat up 106 to 80-150° C. and start 1.5-4 hours of polymer polymerization and reaction 107, and the content of terminal isocyanate is controlled to 0.1-25% by the number of moles and equivalents of isocyanate group (hydroxyl group); for example: (NCO/OH)>1, the high molecular polymerization reaction is complete and is easy to leave NCO functional groups at both ends of the polymer, and the polymer with NCO functional groups at both ends will perform moisture curing crosslinking reaction with water molecules in the air.
3. Add the catalyst 108 under nitrogen atmosphere.
4. After adding the catalyst 108, vacuumize 650-760 mm Hg (109) to remove air bubbles.
5. Unloading into the aluminum foil package 110 of nitrogen atmosphere and sealing.

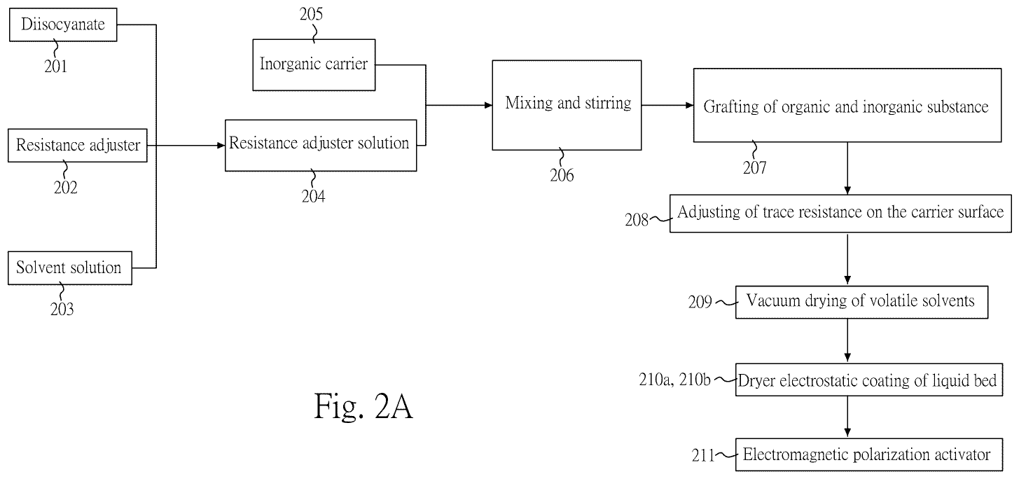

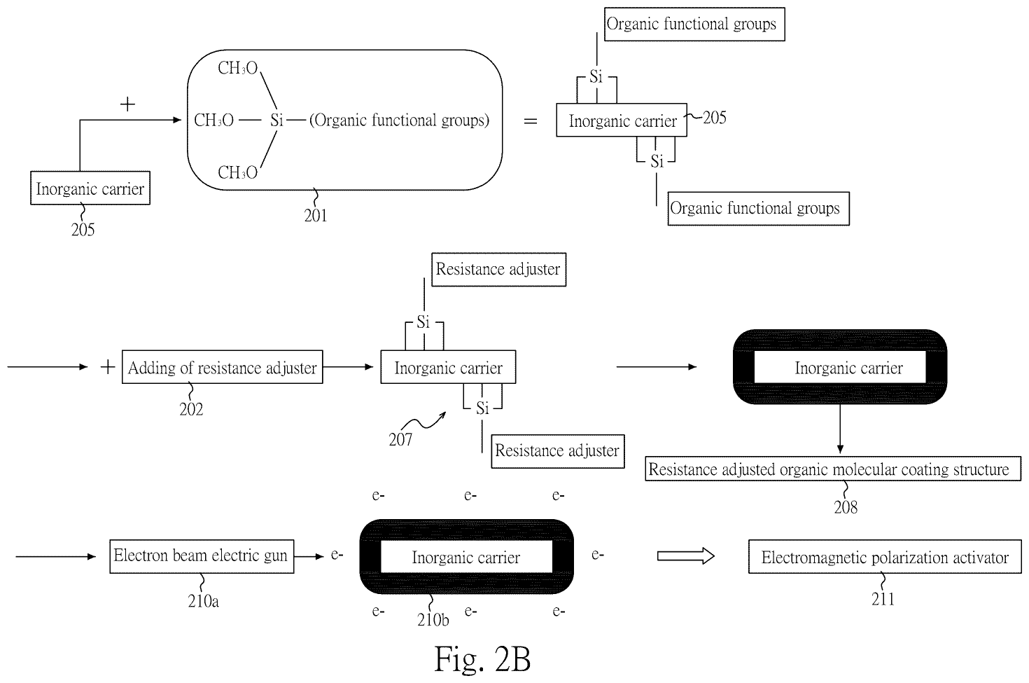

The electromagnetically activated moisture-reactive solid adhesive of the present invention, the manufacturing method of the electromagnetic polarization active agent used in its manufacture is as follows (please refer to FIG. 2A and FIG. 2B):
1. First, one or more of the silane coupling agent 201 and the resistance adjuster 202 are dissolved in solvents 203 such as acetone, butanone, toluene, ethanol, ethyl acetate, and dimethylacetamide, and a resistance adjuster solution 204 with a solid content of (0.1-30%) is obtained.
2. Pour the required amount of the carrier 205 into the solution of the coupling agent 201 and the resistance adjuster 202 and mix and stir (206) for 2-5 hours, so that the surface of the carrier is modified by coupling and grafting of organic and inorganic substances 207 and adjust the trace resistance on the surface of the carrier to 1 mΩ·cm˜1 GΩ·cm208.
3. The above solution is vacuum-dried (209) to completely evaporate the solvent, leaving a solid powder product 210 of the organic molecule-coated carrier.
4. The solid powder (210) surface of the above-mentioned organic molecule-coated carrier is electrostatically charged through a fluidized bed dryer and a high-voltage electron beam gun to obtain the electromagnetic polarization active agent product 211.

The electromagnetically activated moisture-reactive solid adhesive of the present invention can quickly concentrate and disperse the charged structure of the electromagnetically polarized active agent by rapidly changing the positive and negative electric fields, thereby interrupting the moisture-responsive solid adhesive. The hydrogen-bonded crystalline structure makes it liquefied to achieve adhesion.

In conclusion from above, the electromagnetically activated moisture-reactive solid adhesive of the present invention has not been seen in any publications, nor has any similar product been seen on the market, so its novelty should be without doubt. In addition, the unique features and functions of the present invention are far beyond the comparison of the conventional ones, so it is indeed more progressive than the conventional ones, and it complies with the requirements of the Patent Law on the application requirements for invention patents, and the patent application is filed according to law.

The above are only preferred embodiments of the present invention, and the scope of implementation of the present invention cannot be limited with this, that is, the simple equivalent changes and modifications made according 5 to the patent scope of the present invention and the content of the description, should still belong to the scope covered by the patent of the present invention.

What is claimed is:

1. An adhesive, which is an electromagnetically activated moisture-reactive solid adhesive, manufactured by:
(1) One or more formulations of prepolymer 10-95%, tackifier 1-30%, auxiliary 0.01-10%, filler 1-30% (one or more formulations of) are mixed and heated to 100° C.-150° C., dried and dehydrated in a vacuum environment of 650-760 mm Hg for 30 minutes-4 hours to obtain a prepolymerized composition liquid;
(2) Lower the obtained prepolymerization combination liquid below 70° C., add an electromagnetic polarization active agent (EMPA), mix uniformly under nitrogen atmosphere, and slowly add diisocyanate curing agent (Diisocyanate) under nitrogen atmosphere, raising the temperature to 80-150° C., allowing the prepolymer mixture to undergo a high molecular polymerization reaction for 1.5-4 hours, and controlling its terminal isocyanic acid content to be 0.1-25%;
(3) Adding a catalyst under the nitrogen atmosphere to accelerate the polymerization reaction;
(4) Under a vacuum environment of 650-760 mm Hg, remove the nitrogen in the reaction chamber, remove the bubbles from the polymerization reaction product, and obtain a solid adhesive;
(5) Unload the material into a nitrogen-protected aluminum foil package and seal it, which is a commodity,
wherein, the manufacture of said electromagnetic polarization active agent is:
(1) Dissolve one or more of the silane coupling agent and the resistance adjuster are dissolved in acetone, methyl ethyl ketone, toluene, ethanol, ethyl acetate, dimethylacetamide, etc., to obtain a solid content of (0.1-30%) resistance adjuster solution;
(2) Pour the required amount of the carrier into the above-mentioned coupling agent and resistance adjusting agent solution and mix and stir for 2-5 hours, so that the surface of the carrier is modified by coupling and grafting of organic and inorganic substances and the trace amount of the carrier surface has the resistance adjusted to 1mΩ·cm˜1 GΩ·cm;
(3) Vacuum-dry the above solution to completely evaporate the solvent, leaving a solid powder product of organic molecule-coated carrier;
(4) Pass the above-mentioned solid powder product through a fluidized bed dryer and a high-voltage electron beam gun to electrostatically charge the surface of the said solid powder coated with organic molecules on the carrier to obtain the product of electromagnetic polarization active agent.

2. The electromagnetically activated moisture-reactive solid adhesive as claimed in claim 1, wherein the prepolymer is a substance formed by the initial polymerization of a monomer, and its terminated group is a hydroxyl group (Hydroxy bond-OH) prepolymer.

3. The electromagnetically activated moisture-reactive solid adhesive as claimed in claim 1, wherein the prepolymer is formed by mixing one or a plurality of the followings: (a) polyester polyol, (b) polyether polyol, (c) polytetrahydrofuran type prepolymer (polytetrmethylene ether glycol polyol), (d) polycaprolactone type prepolymer (polycaprolactone polyol), (e) polycarbonate type prepolymer (polycarbonate polyol), (f) poly-terminated hydroxyl acrylate type prepolymer (polyhydroxyl-terminated acrylate polyol), (g) polyhydroxyl-terminated polybutadiene, (h) polyhydroxyl-terminated epoxy prepolymer (polyhydroxyl-terminated epoxy).

4. The electromagnetically activated moisture-reactive solid adhesive as claimed in claim 1, wherein the curing agent is an isocyanate curing agent.

5. The electromagnetically activated moisture-reactive solid adhesive as claimed in claim 4, wherein the curing agent is one or a plurality of the followings: (a) diphenylmethane diisocyanate; (b) toluene diisocyanate; (c) 1,5-Naphthalene diisocyanate; (d) isocyanate diisocyanate; (e) hydrogenated diphenylmethane diisocyanate (4,4′-dicyclohexylmethane diisocyanate).

6. The electromagnetically activated moisture-reactive solid adhesive as claimed in claim 1, wherein the tackifier is one or more of: (a) abietic resin; (b) terpene resin; (c) hydrocarbon resin, HCR.

7. The electromagnetically activated moisture-reactive solid adhesive as claimed in claim 1, wherein the additives are one or more of the followings: (a) antifoaming agent, (b) leveling agent, (c) anti-shrinkage antiratering agent, (d) dilatant thickener, (e) thixotropy.

8. The electromagnetically activated moisture-reactive solid adhesive as claimed in claim 1, wherein the filler is at least one of: (a) talcum powder, (b) calcium carbonate, (c) kaolin, etc.

9. The electromagnetically activated moisture-reactive solid adhesive as claimed in claim 1, wherein the catalyst is: a) dibutyltin dilaurate; b) N, N-Dimethyltrimethylenediamines.

10. The electromagnetically activated moisture-reactive solid adhesive as claimed in claim 1, wherein the electromagnetically polarized active agent carrier is the following powdery, granular compounds: (a) quartz, (b) zirconia, (c) silicon carbide, (d) zinc oxide, (e) calcium oxide, (f) magnesium oxide, (g) copper oxide, (h) calcium carbonate, (i) mica, (j) iron oxide, (k) aluminum oxide (alumina), (I) carbon, (m) graphite and its isomers, (n) solid polymer microspheres, (o) hollow polymer microspheres (silica microspheres).

11. The electromagnetically activated moisture-reactive solid adhesive as claimed in claim 1, wherein the Resistance adkister is a conductive polymer used to adjust the micro-resistance of the carrier surface, which may include at least one of: (a) poly (3,4-ethylenedioxythiophene): polythiophene; (b) silver nanowire; (c) carbon nanotube; (d) (e) octylphenol polyoxyethylene ether graphene; [Tetramethylbutyl) phenoxy] ethoxy) ethanol]; (f) at least one of monoalkyl ether phosphate (monoalkyl ether phosphate).

12. The electromagnetically activated moisture-reactive solid adhesive as claimed in claim 1, wherein the coupling agent is at least one of the following: (a) vinyl trimethoxy silane (dibutyltin dilaurate), (b) vinyl triethoxy silane (vinyltriethoxy silane), (c) 3-isocyanatopropyl (trimethoxy) silane, (d) (3-aminopropyl) triethoxysilanel, (e) (3-aminopropyl) trimethoxysilane.
